(19) United States
(12) Patent Application Publication
(10) Pub. No.: US 2024/0330697 A1
(43) Pub. Date: Oct. 3, 2024

(54) MULTI-AGENT REINFORCEMENT LEARNING BY RECEIVING AND COMBINING HIDDEN LAYERS AT EACH AGENT

(71) Applicant: HRL Laboratories, LLC, Malibu, CA (US)

(72) Inventors: Sean SOLEYMAN, Calabasas, CA (US); Alex YAHJA, Agoura Hills, CA (US); Joshua G. FADAIE, Saint Louis, MO (US); Fan H. HUNG, Los Angeles, CA (US); Deepak KHOSLA, Camarillo, CA (US)

(73) Assignee: HRL Laboratories, LLC, Malibu, CA (US)

(21) Appl. No.: 18/193,497

(22) Filed: Mar. 30, 2023

(51) Int. Cl. G06N 3/092; G06N 3/044

(52) U.S. Cl. CPC G06N 3/092; G06N 3/044

(57) ABSTRACT

A local agent of a multi-agent reinforcement learning (MARL) system is disclosed, the local agent comprising a MARL network comprising at least one local hidden layer responsive to a plurality of local observations. A transmitter is configured to transmit an output of the local hidden layer to at least one remote agent, and a receiver is configured to receive an output of a remote hidden layer from the at least one remote agent. A combiner module is configured to combine the local hidden layer output with the remote hidden layer output to generate a combined hidden layer output, wherein the MARL network is configured to process the combined hidden layer output to generate at least one action value for the local agent.

### STATEMENT REGARDING FEDERAL FUNDING

This invention was made under U.S. Government contract N00014-21-C-2043. The U.S. Government has certain rights in this invention.

### TECHNICAL FIELD

This specification relates to multi-agent reinforcement learning (MARL).

### BACKGROUND

Multi-Agent Reinforcement Learning (MARL) systems employ deep learning algorithms in order to train and control multiple agents (e.g., automobiles, aircraft, robots, machines, etc.) interacting within a common environment. At discrete time-steps, each agent takes an action which achieves an individual predetermined goal, wherein the MARL network learns a policy for each agent such that working collectively the agents achieve an overall system goal. A simple approach explored previously has been to extend the single-agent RL algorithms to multi-agent algorithms by training each agent as an independent learner. However, a problem with this approach is the system becomes non-stationary since each agent's actions toward local goals will impact the observable environment.

### DESCRIPTION OF DRAWINGS

FIG. 1A shows a multi-agent system (in this case drones) according to an embodiment wherein each local agent transmits a hidden layer to the other agents and receives a hidden layer from the other remote agents.

FIG. 1B is a flow diagram according to an embodiment wherein each local agent combines its hidden layer output with the hidden layer outputs received from the remote agents to generate a combined hidden layer output.

FIG. 2A shows an embodiment wherein each local agent comprises an attention network configured to combine the local and remote hidden layer outputs into the combined hidden layer output.

FIG. 2B shows an example attention network according to an embodiment.

FIG. 3 shows an embodiment wherein each local agent comprises a max pooling layer or an averaging pooling layer used to combine the local and remote hidden layer outputs into the combined hidden layer output.

FIG. 4 is source code according to an embodiment for combining the local and remote hidden layer outputs using an attention network.

FIG. 5 is source code according to an embodiment for implementing a multi-head attention network.

FIG. 6 is source code according to an embodiment for combining the local and remote hidden layer outputs using a MAX pooling layer.

FIG. 7 is source code according to an embodiment for combining the local and remote hidden layer outputs using an AVERAGE pooling layer.

### DETAILED DESCRIPTION

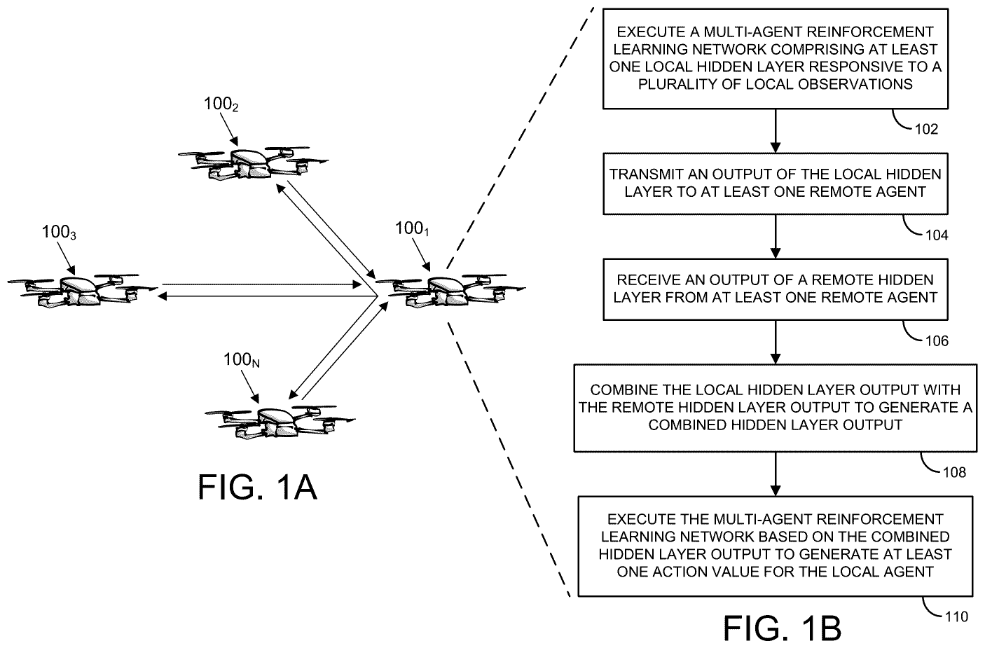

FIG. 1A shows a local agent 1001 of a multi-agent reinforcement learning (MARL) system according to an embodiment comprising a plurality of agents 1001-100N (a plurality of drones in this embodiment). The local agent 1001 comprises a computer implemented MARL network comprising at least one local hidden layer responsive to a plurality of local observations (block 102 of FIG. 1B). The local agent further comprises a transmitter configured to transmit an output of the local hidden layer to at least one remote agent (block 104), and a receiver configured to receive an output of a remote hidden layer from the at least one remote agent (block 106). A computer implemented combiner module within the local agent is configured to combine the local hidden layer output with the remote hidden layer output to generate a combined hidden layer output (block 108), wherein the MARL network is configured to process the combined hidden layer output to generate at least one action value for the local agent (block 110).

MARL networks may be generally understood by extending a single-agent RL network to a multi-agent RL network wherein each agent's action affects the observable environment. The agent at time period t observes state sₜ∈S in which S is the state space, takes action aₜ∈A(sₜ) where A(sₜ) is the valid action space for state sₜ, executes the action in the environment to receive reward r(sₜ, aₜ, sₜ₊₁)∈R, and then transfer to the new state sₜ₊₁∈S. The process runs for the stochastic T time-steps which is the length of an episode. Markov Decision Process (MDP) provides a framework to characterize and study this problem where the agent has full observability of the state. The goal of the agent in an MDP is to determine a policy π: S→A, a mapping of the state space S to the action space A, that maximizes the long-term cumulative discounted rewards:

$$J = {𝔼}_{π , {s}_{0}} [ {\sum }_{t = 0}^{∞} {γ}^{t} r ( {s}_{t} , {a}_{t} , {s}_{t + 1} ) \vert {a}_{t} = π ( . \vert {s}_{t} ) ]$$

where γ∈[0,1] is the discounting factor. Accordingly, the value function starting from state s and following policy π denoted by V^{π}(s):

$${V}^{π} ( s ) = {𝔼}_{π} [ {\sum }_{t = 0}^{∞} {γ}^{t} r ( {s}_{t} , {a}_{t} , {s}_{t + 1} ) \vert {a}_{t} \sim π ( . \vert {s}_{t} ) , {s}_{0} = s ]$$

and given action a, the Q-value:

$${Q}^{π} ( s , a ) = {𝔼}_{π} [ {\sum }_{t = 0}^{∞} {γ}^{t} r ( {s}_{t} , {a}_{t} , {s}_{t + 1} ) \vert {a}_{t} \sim π ( . \vert {s}_{t} ) , {s}_{0} = s , {a}_{0} = a ]$$

Given a known state transition probability distribution p(sₜ₊₁|sₜ, aₜ) and reward matrix r(sₜ, aₜ), the following equation holds for all state sₜ at any time step t, including the optimal values:

$${V}^{π} ( {s}_{t} ) = {\sum }_{a ∈ 𝒜 ( {s}_{t} )} π ( a \vert {s}_{t} ) {\sum }_{{s}^{′} ∈ 𝒮} p ( {s}^{′} \vert {s}_{t} , a ) [ r ( {s}_{t} , a ) + γ {V}^{π} ( {s}^{′} ) ]$$

where s′ denotes sₜ₊₁. Through maximizing over the actions, the optimal state-value and optimal policy:

$${V}^{{π}^{*}} ( {s}_{t} ) = {max}_{α} {\sum }_{{s}^{′}} p ( {s}^{′} \vert {s}_{t} , a ) [ r ( {s}_{t} , a ) + γ {V}^{{π}^{*}} ( {s}^{′} ) ]$$

and the optimal Q-value for each state-action:

$${Q}^{{π}^{*}} ( {s}_{t} , {a}_{i} ) {= \sum }_{{s}^{′}} p ( {s}^{′} \vert {s}_{t} , {a}_{t} ) [ r ( {s}_{t} , {a}_{t} ) + γ {max}_{{α}^{′}} {Q}^{{π}^{*}} ( {s}^{′} , {a}^{′} ) ]$$

one can obtain an optimal policy π* through learning directly Q^{π*}(sₜ, aₜ). The relevant methods are called value-based methods. However, in the real world knowledge of the environment i.e., p(sₜ₊₁|sₜ, aₜ) is usually not available and the optimal policy cannot be determined using the above equations. In order to address this issue, learning the state-value, or the Q-value, through sampling has been a common practice. This approximation requires only samples of state, action, and reward that are obtained from the interaction with the environment. In the earlier approaches, the value for each state/state-action was stored in a table and was updated through an iterative approach. The “value iteration” and “policy iteration” are two known algorithms in this category that can attain the optimal policy. However, these approaches are not practical for tasks with enormous state/action spaces due to dimensionality. This issue can be mitigated through “function approximation” in which parameters of a function need to be learned by utilizing supervised learning approaches. The function approximator with parameters θ results in policy π_{θ}(a|s). The function approximator with parameters θ can be a simple linear regression model or a deep neural network. Given the function approximator, the goal of an RL algorithm can be re-written to maximize the utility function:

$$J ( θ ) = {𝔼}_{a \sim {π}_{θ} ( . \vert s ) , s \sim {ρ}_{{π}_{θ}}} {\sum }_{t = 0}^{∞} {γ}^{t} r ( {s}_{t} , {a}_{t} ; θ )$$

where the expectation is taken over the actions and the distribution for state occupancy. In a different class of approaches referred to as “policy-based,” the policy is directly learned which determines the probability of choosing an action for a given state. In either of these approaches, the goal is to find parameters θ which maximizes utility function J(θ) through learning with sampling.

As described above, extending the single-agent RL algorithm to the multi-agent RL algorithm becomes prohibitively complex due to the large number of observations across all of the agents, a problem exacerbated as the number of agents in the system increases. The embodiments disclosed herein alleviate this problem by learning and communicating only the state information that optimizes the above utility function (θ), and by combining the state information at each agent so as to consolidate the information processed by each agent's MARL network (as compared to simply concatenating and processing all of the state information). In addition, in one embodiment the state information is combined into a fixed size output independent of the number and/or size of the remote hidden layer outputs received from the remote agents. This embodiment facilitates the drop in/out of agents due to proximity constraints and/or noisy communication channels without increasing the complexity of the down-stream processing.

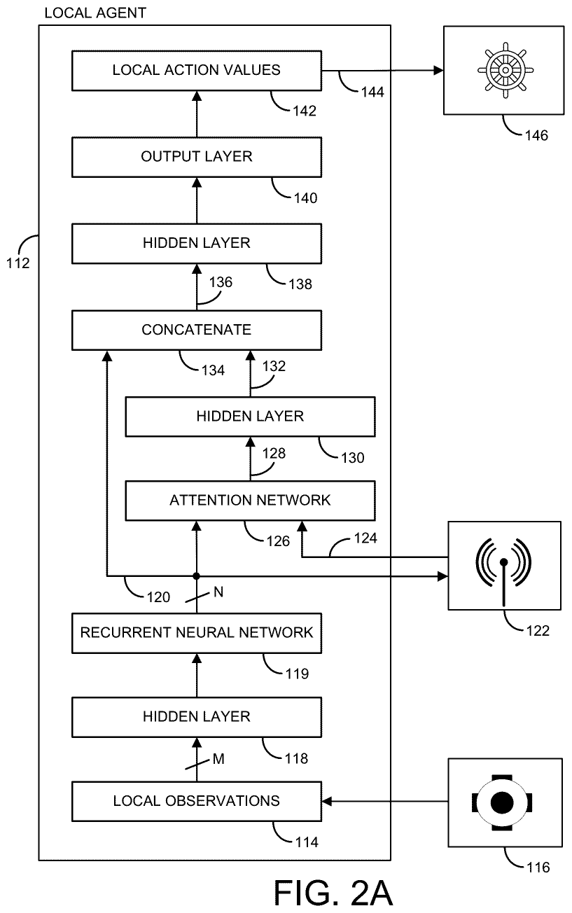

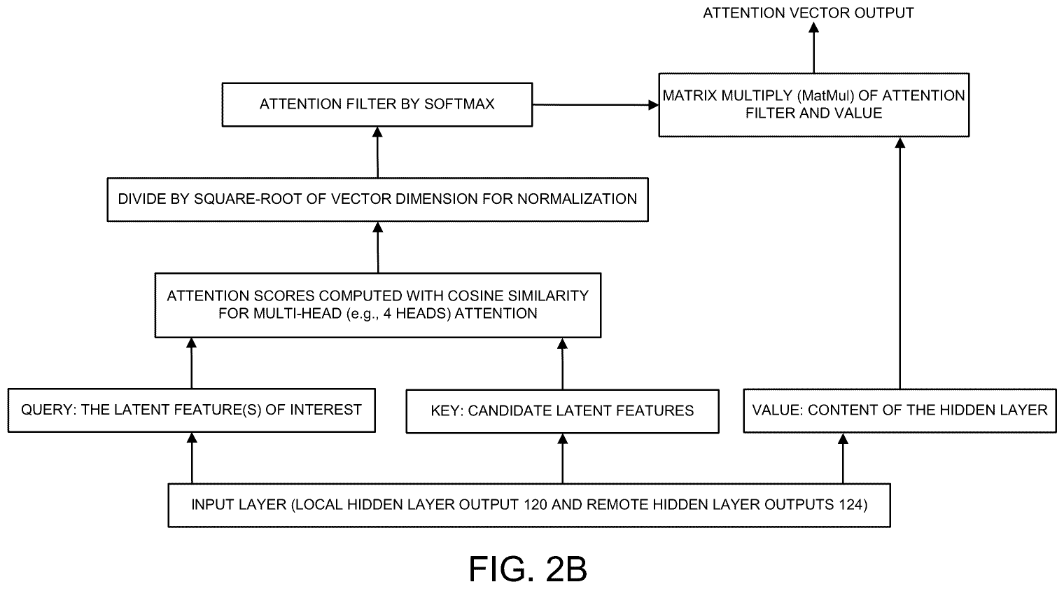

FIG. 2A shows an embodiment wherein each local agent of FIG. 1A comprises a computer system 112 for implementing a MARL network, wherein the computer system 112 is configured to receive M local observations 114 associated with the environment which may, for example, be sensed using any suitable environment sensor 116 (e.g., visual sensors, lidar sensors, audio sensors, location sensors, movement sensors, etc.). A hidden layer 118 (e.g., a multilayer perceptron (MLP) neural network) processes the M local observations 114, wherein the output of the hidden layer 118 is processed by a recurrent neural network (RNN) 119. The output of the RNN 119 (which in this embodiment is considered the output of a hidden layer) comprises N state values 120 which are transmitted (via any suitable transmitter/receiver 122 using, for example, electromagnetic radio or light waves, sound waves, etc.) to other remote agents of the MARL system. In one embodiment, the effect of the hidden layer 118 and RNN 119 is to learn the more important state information from the local observations 114 which maximizes the above utility function (θ) and discard (filter out) the less important information. Accordingly in this embodiment, the information size of the N state values 120 output by the RNN 119 is less than the information size of the M local observations, thereby reducing the amount of information transmitted to the remote agents as compared to transmitting all of the M local observations to the remote agents and letting the remote agents determine the important information. In other words, this embodiment reduces the transmission cost by reducing the amount of information transmitted, as well as reduces the computational cost of each agent.

In the embodiment of FIG. 2A, the transmitter/receiver 122 receives a remote hidden layer output 124 from other remote agents (e.g., the output of an RNN) and combines the local hidden layer output 120 with the remote hidden layer outputs 124 using a suitable attention network 126 in order to consolidate the state information into a combined hidden layer output 128. In one embodiment, the size of the combined hidden layer output 128 remains fixed independent of the number of remote hidden layer outputs received from remote agents. In the embodiment of FIG. 2A, the combined hidden layer output 128 is processed by a hidden layer 130, wherein the output 132 of the hidden layer 130 is concatenated 134 with the local hidden layer output 120 for further down-stream processing. In this manner, the resulting concatenated state information 136 is effectively weighted evenly between the state information generated from the local observations, and the state information generated from combining the local and remote hidden layer outputs. The concatenated state information 136 is processed by a hidden layer 138 followed by an output layer 140 which generates a probability distribution 142 for each action that may be taken by the agent, wherein a control signal 144 is generated for a selected one of the actions (e.g., based on the RL algorithm). The agent may perform any suitable action 146 in response to the control signal 144, such as controlling a direction of the agent as it moves through the environment.

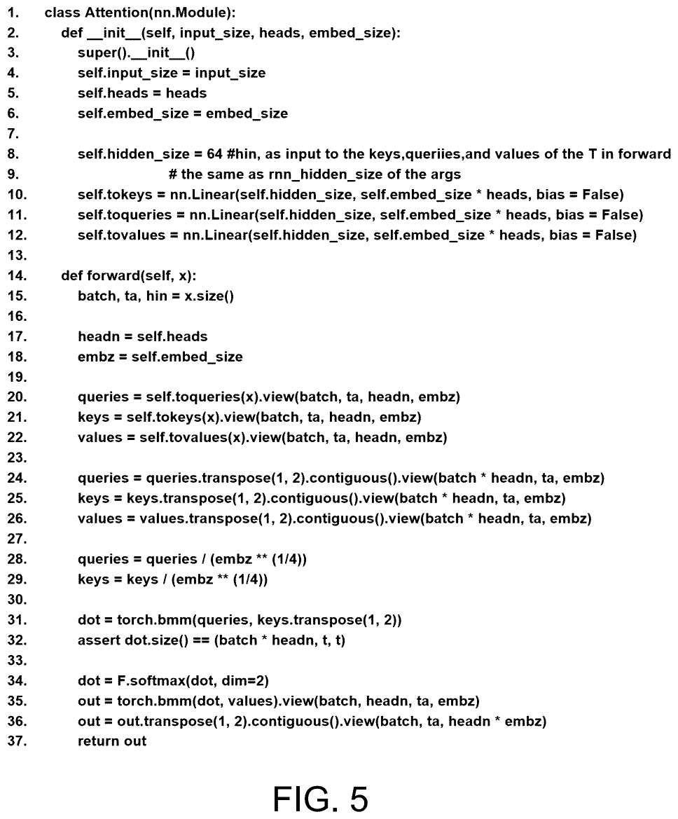

FIG. 2B shows an embodiment for the attention network 126 of FIG. 2A as comprising a multi-head attention network, wherein an input layer receives the local hidden layer output 120 and the remote hidden layer outputs 124. The concepts of multi-head attention networks are well known to those skilled in the art and may be considered generally as the differential weighting of the significance of each part of the input data. Accordingly, the attention vector output by the multi-head attention network of FIG. 2B effectively consolidates into a more condensed representation the input layer by focusing attention on the more important data and “filtering out” less important data. In one embodiment, the attention vector output by the multi-head attention network has a fixed size independent of the size of the input layer which provides automatic scaling as the number of agents drop in/out of the environment. There are numerous articles available on the Internet describing the operation and implementation of each component of the multi-head attention network shown in FIG. 2B, such as described in Yasuto Tamura, “Multi-head attention mechanism: “queries”, “keys”, and “values,” over and over again,” Apr. 7, 2021, www.data-science-blog.com/blog/2021/04/07/multi-head-attention-mechanism. In addition, each component of the multi-head network shown in FIG. 2B may be implemented using well known machine learning tools (e.g., PyTorch, TensorFlow, etc.) an example of which is shown in the source code of FIG. 5.

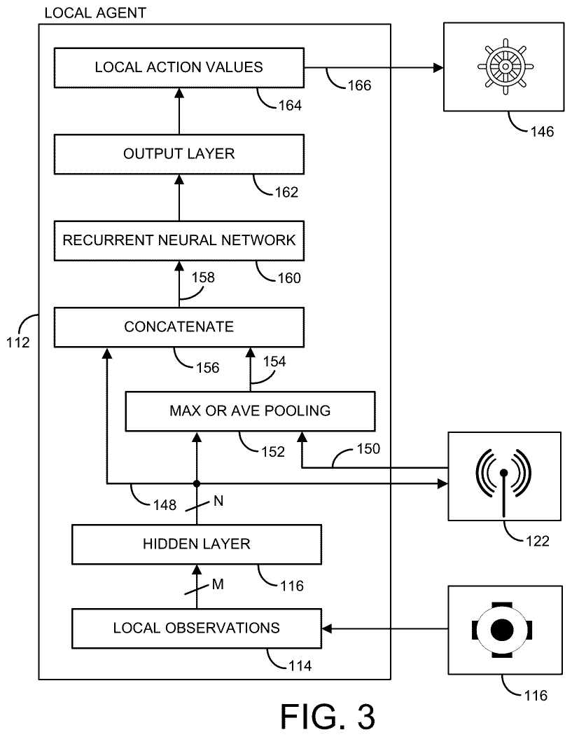

Although the embodiment of FIG. 2A employs an attention network 126 to combine and effectively consolidate the local and remote hidden layer outputs, any suitable technique may be employed. In an alternative embodiment shown in FIG. 3, the local hidden layer output 148 (of hidden layer 116) is combined with the corresponding remote hidden layer outputs 150 received from the remote agents using a MAX or AVERAGE pooling layer 152. In one embodiment, the MAX pooling layer may select the highest value out of a patch of values in the local and remote hidden layer outputs (148 and 150) in order to generate the combined hidden layer output 154. For example, the patch of values may be configured as a collection of values each representing one (or a set) of the respective local and remote hidden layer outputs (148 and 150). In one embodiment, the AVERAGE pooling layer may select the average value out of a patch of values in the local and remote hidden layer outputs (148 and 150). In another embodiment (not shown), the local and remote hidden layer outputs may be combined using any suitable combination of MAX/AVERAGE pooling. In one embodiment, the MAX or AVERAGE pooling layers effectively down-sample the local and remote hidden layer outputs in order to consolidate the state information into a more compact (and in one embodiment fixed) representation. Similar to the attention network 126 described with reference to FIG. 2A, the down-sampling of the remote and hidden layer outputs into a fixed representation of state information provides automatic scaling as the number of agents drop in/out of the environment.

In the embodiment of FIG. 3, the combined hidden layer output 154 is concatenated 156 with the local hidden layer output 148 for further downstream processing. In this manner, the resulting concatenated state information 158 is effectively weighted evenly between the state information generated from the local observations, and the state information generated from combining the local and remote hidden layer outputs. The concatenated state information 158 is processed by a recurrent neural network (RNN) 160 followed by an output layer 162 which generates a probability distribution 164 for each action that may be taken by the agent, wherein a control signal 166 is generated for a selected one of the actions (e.g., based on the RL algorithm).

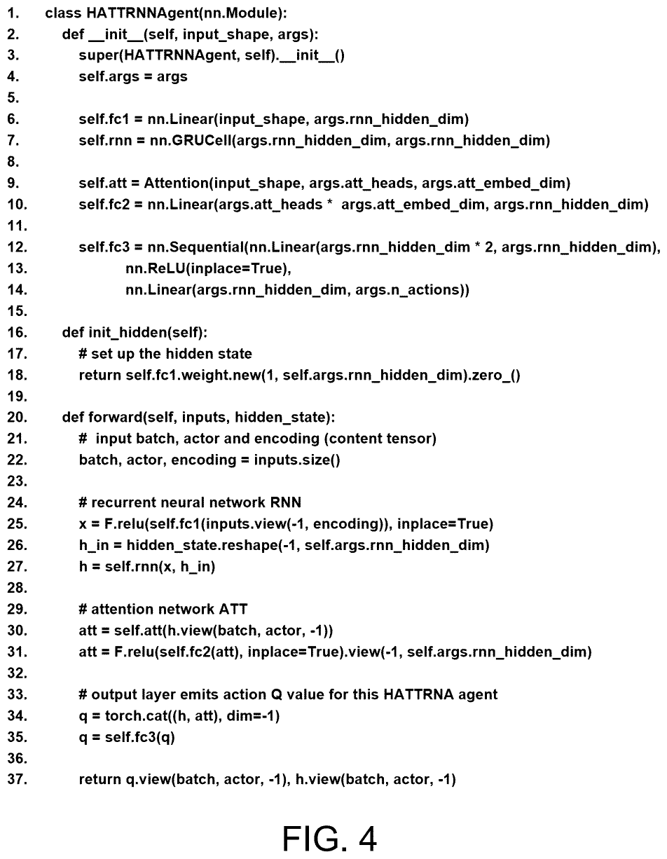

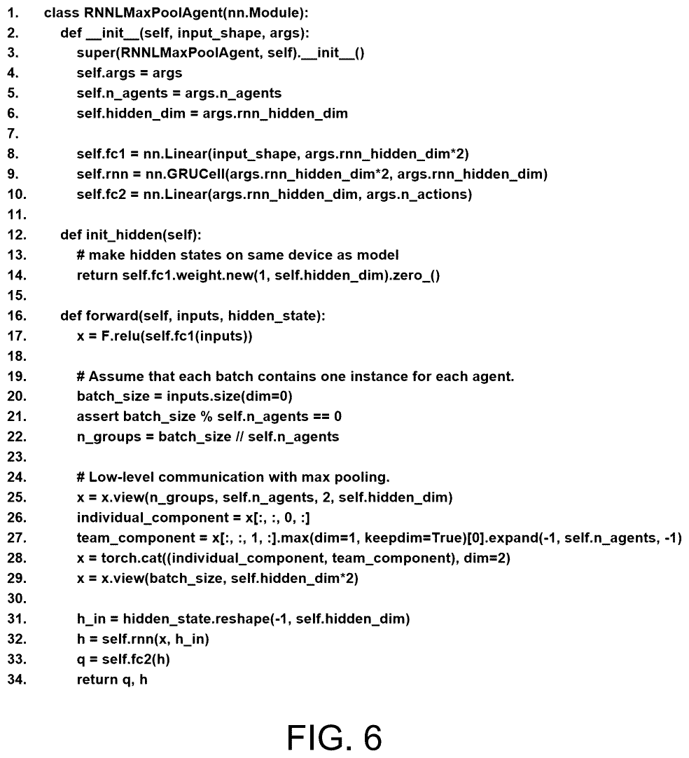

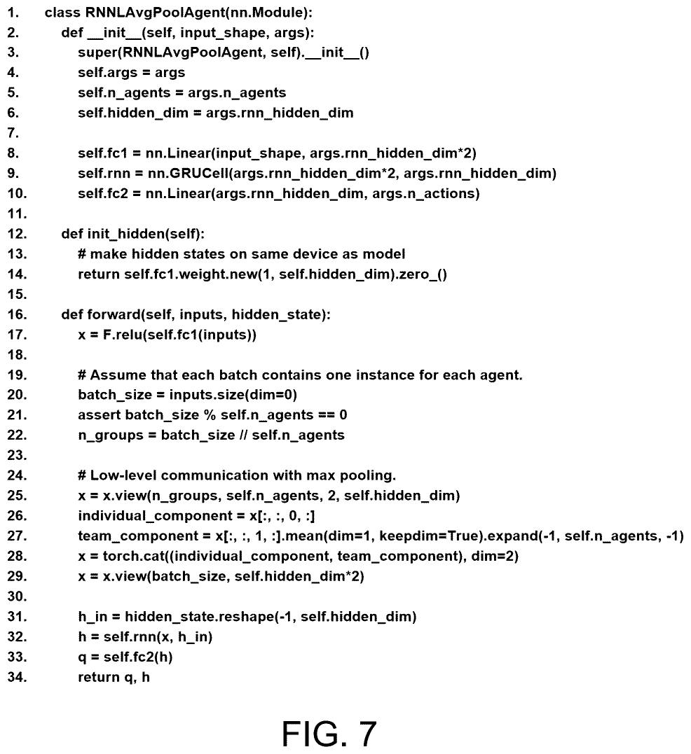

As described above, each component shown in the MARL network within each of the agents may be implemented using any well known machine learning tool (e.g., PyTorch, TensorFlow, etc.). FIG. 4 shows an example embodiment of Python/PyTorch code for implementing the MARL network shown in FIG. 2A. In this embodiment, the local and remote hidden layer outputs 120 and 124 are inputs to the “forward” procedure call (line 20); in other words, the remote hidden layer outputs 124 have already been received over the communication channel. The attention network 126 of FIG. 2A is executed on line 30 of FIG. 4 with the corresponding Python/PyTorch code shown in FIG. 5. FIG. 6 shows example Python/PyTorch code for implementing the MAX pooling embodiment shown in FIG. 3, and FIG. 7 shows example Python/PyTorch code for implementing the AVERAGE pooling embodiment shown in FIG. 3. In these embodiments, the local and remote hidden layer outputs 148 and 150 are inputs to the “forward” procedure call (line 16); in other words, the remote hidden layer outputs 150 have already been received over the communication channel.

In one embodiment, the MARL networks of the agents are trained by simulating a reception of remote state information communicated from the other agents, and by simulating a periodic loss of the communication with the other agents. In this embodiment, the MARL networks within each agent are optimized for operation in real time in a manner that accounts for a variable number of agents dropping in/out of the environment.

In one embodiment, the computer system in the above described embodiments comprises one or more processors configured to perform calculations, processes, operations, and/or functions associated with a program or algorithm. The processes and steps in the example embodiments may be instructions (e.g., software program) that reside within a non-transitory computer readable memory executed by the one or more processors of computer system. When executed, these instructions cause the computer system to perform specific actions and exhibit specific behavior for the example embodiments disclosed herein. The processors may include one or more of a single processor or a parallel processor, an application-specific integrated circuit (ASIC), programmable logic array (PLA), complex programmable logic device (CPLD), or a field programmable gate array (FPGA).

The computer system may be configured to utilize one or more data storage units such as a volatile memory unit (e.g., random access memory or RAM such as static RAM, dynamic RAM, etc.) coupled with address/data bus. Also, the computer system may include a non-volatile memory units (e.g., read-only memory (“ROM”), programmable ROM (“PROM”), erasable programmable ROM (“EPROM”), electrically erasable programmable ROM “EEPROM”), flash memory, etc.) coupled with an address/data bus. A non-volatile memory unit may be configured to store static information and instructions for a processor. Alternatively, the computer system may execute instructions retrieved from an online data storage unit such as in “Cloud” computing.

The computer system may include one or more interfaces configured to enable the computer system to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

The computer system may include an input device configured to communicate information and command selections to a processor. Input device may be an alphanumeric input device, such as a keyboard, that may include alphanumeric and/or function keys. The computer system may further include a cursor control device configured to communicate user input information and/or command selections to a processor. The cursor control device may be implemented using a device such as a mouse, a track-ball, a track-pad, an optical tracking device, or a touch screen. The cursor control device may be directed and/or activated via input from an input device, such as in response to the use of special keys and key sequence commands associated with the input device. Alternatively, the cursor control device may be configured to be directed or guided by voice commands.

The processes and steps for the example may be stored as computer-readable instructions on a compatible non-transitory computer-readable medium of a computer program product. Computer-readable instructions include a set of operations to be performed on a computer, and may represent pieces of a whole program or individual, separable, software modules. For example, computer-readable instructions include computer program code (source or object code) and “hard-coded” electronics (i.e. computer operations coded into a computer chip). The computer-readable instructions may be stored on any non-transitory computer-readable medium, such as in the memory of a computer or on external storage devices. The instructions are encoded on a non-transitory computer-readable medium.

A number of example embodiments have been described. Nevertheless, it will be understood that various modifications may be made without departing from the spirit and scope of the devices and methods described herein.

What is claimed is:

1. A local agent of a multi-agent reinforcement learning (MARL) system, the local agent comprising:
a computer implemented MARL network comprising at least one local hidden layer responsive to a plurality of local observations;
a transmitter configured to transmit an output of the local hidden layer to at least one remote agent;
a receiver configured to receive an output of a remote hidden layer from the at least one remote agent; and
a computer implemented combiner module configured to combine the local hidden layer output with the remote hidden layer output to generate a combined hidden layer output, wherein the MARL network is configured to process the combined hidden layer output to generate at least one action value for the local agent.

2. The local agent as recited in claim 1, wherein a size M of the local observations is greater than a size N of the output of the local hidden layer.

3. The local agent as recited in claim 1, wherein the transmitter comprises a wireless transmitter and the receiver comprises a wireless receiver.

4. The local agent as recited in claim 1, wherein the MARL network comprises a recurrent neural network comprising the local hidden layer.

5. The local agent as recited in claim 4, wherein the combiner module comprises an attention network.

6. The local agent as recited in claim 5, wherein the MARL network further comprises a computer implemented concatenate module configured to generate a concatenated output in response to the output of the local hidden layer and an output of the attention network.

7. The local agent as recited in claim 6, wherein the MARL network further comprises an output layer responsive to the concatenate module and configured to generate the at least one action value for the local agent.

8. The local agent as recited in claim 1, wherein the combiner module comprises one of a max pooling layer or an average pooling layer.

9. The local agent as recited in claim 1, wherein the local agent is a vehicle and the action value is for controlling at least one of a speed or a steering of the vehicle.

10. A multi-agent reinforcement learning (MARL) system comprising a plurality of agents communicating with one another, each agent comprising:
a computer implemented MARL network comprising at least one local hidden layer responsive to a plurality of local observations;
a transmitter configured to transmit an output of the local hidden layer to at least one of the other agents;
a receiver configured to receive an output of a remote hidden layer from the at least one of the other agents; and
a computer implemented combiner module configured to combine the local hidden layer output with the remote hidden layer output to generate a combined hidden layer output, wherein the MARL network is configured to process the combined hidden layer output to generate at least one action value for the corresponding agent.

11. The MARL system as recited in claim 10, wherein a size M of the local observations is greater than a size N of the output of the local hidden layer.

12. The MARL system as recited in claim 10, wherein the transmitter comprises a wireless transmitter and the receiver comprises a wireless receiver.

13. The MARL system as recited in claim 10, wherein the MARL network comprises a recurrent neural network comprising the local hidden layer.

14. The MARL system as recited in claim 13, wherein the combiner module comprises an attention network.

15. The MARL system as recited in claim 14, wherein the MARL network further comprises a computer implemented concatenate module configured to generate a concatenated output in response to the output of the local hidden layer and an output of the attention network.

16. The MARL system as recited in claim 15, wherein the MARL network further comprises an output layer responsive to the concatenate module and configured to generate the at least one action value for the local agent.

17. The MARL system as recited in claim 10, wherein the combiner module comprises one of a max pooling layer or an average pooling layer.

18. The MARL system as recited in claim 10, wherein at least one of the agents is a vehicle and the at least one action value is for controlling at least one of a speed or a steering of the vehicle.

19. A computer implemented method of training a multi-agent reinforcement learning (MARL) system comprising a plurality of agents communicating with one another, the method comprising:
using a computer to train a MARL network within one of the agents by simulating a reception of remote state information communicated from one of the other agents; and
using the computer to simulate a periodic loss of communication with the other agent.

20. The MARL system as recited in claim 19, wherein the remote state information comprises a hidden layer output of a MARL network within the other agent.
